(19) United States
(12) Patent Application Publication
(10) Pub. No.: US 2008/0231553 A1
(43) Pub. Date: Sep. 25, 2008

(54) PLASMA DISPLAY DEVICE

(75) Inventor: Ki-Dong KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/050,332

(22) Filed: Mar. 18, 2008

(30) Foreign Application Priority Data
Mar. 21, 2007 (KR) 10-2007-0027725

(51) Int. Cl. G09G 3/28

(52) U.S. Cl. 345/60

(57) ABSTRACT

A plasma display device includes: a plasma display panel including an address electrode disposed on a first substrate, a pair of first and second display electrodes disposed on a second substrate and crossing the address electrode, a dielectric layer covering the first and second display electrodes on the second substrate, an MgO protective layer covering the dielectric layer on the second substrate, and discharge gases filled between the first and second substrates; a driver that drives the plasma display panel; and a controller that controls a sustain pulse width of a sustain period to be 1 to 3.5 μs. An atomic ratio of O to Mg in the MgO protective layer ranges from 1.0 to 0.98. The plasma display device shows improved discharge stability and display quality due to reduced statistical delay time by controlling the atomic ratio of O to Mg in the MgO protective layer to a range of 1.0 to 0.98.

### CROSS-REFERENCE TO RELATED APPLICATION

This application claims the benefit of Korean Application No. 2007-27725 filed Mar. 21, 2007, in the Korean Intellectual Property Office, the disclosure of which is incorporated herein by reference.

### BACKGROUND OF THE INVENTION

1. Field of the Invention

Aspects of the present invention relate to a plasma display device. More particularly, the aspects of the present invention relate to a plasma display panel that has an improved discharge stability and discharge quality due to a reduced statistical delay time.

2. Description of the Related Art

A plasma display panel is a display device that forms an image by exciting a phosphor layer with vacuum ultraviolet (VUV) rays generated by gas discharge in discharge cells.

A plasma display panel displays text and/or graphics by using light emitted from plasma that is generated by the gas discharge. An image is formed by applying a predetermined level of voltage to two electrodes situated in a discharge space of the plasma display panel to induce plasma discharge between the two electrodes and exciting a phosphor layer that is formed in a predetermined pattern by ultraviolet rays generated from the plasma discharge. (The two electrodes situated in the discharge space of the plasma display panel are hereinafter referred to as the “display electrodes.”)

Generally, the plasma display panel includes a dielectric layer that covers the two display electrodes and a protective layer on the dielectric layer to protect the dielectric layer. The protective layer is mainly composed of MgO, which is transparent to allow visible light to permeate and which exhibits excellent protective performance for the dielectric layer and also produces secondary electron emission. Recently, however, alternatives and modifications for the MgO protective layer have been researched.

The MgO protective layer has a sputtering resistance characteristic that lessens the ionic impact of the discharge gas upon discharge while the plasma display device is driven and protects the dielectric layer. Further, an MgO protective layer in the form of a transparent protective thin film reduces the discharge voltage through emitting of secondary electrons. Typically, the MgO protective layer is coated on the dielectric layer in a thickness of 5000 to 9000 Å.

Accordingly, the components and the membrane characteristics of the MgO protective layer significantly affect the discharge characteristics. The membrane characteristics of the MgO protective layer are significantly dependent upon the components and the coating conditions of deposition. It is desirable to develop optimal components for improving the membrane characteristics.

It is desirable to improve the discharge stability of the high-definition plasma display panel (PDP) through an improvement of the response speed. The high-definition plasma display panel should respond to a rapid scan speed such that a stable discharge in which all addressing is performed is established. The speed of the response to rapid scanning is determined by the formative delay time (Tf) and the statistical delay time (Ts).

The above information disclosed in this Background section is only for enhancement of understanding of the background of the invention and therefore it may contain information that does not form the prior art that is already known in this country to a person of ordinary skill in the art.

### SUMMARY OF THE INVENTION

According to an embodiment of the present invention, there is provided a plasma display panel that has improved discharge stability and discharge quality due to reduced statistical delay time.

According to an embodiment of the present invention, there is provided a plasma display device that includes a plasma display panel comprising an address electrode disposed on a first substrate, a pair of first and second display electrodes disposed on the second substrate and crossing the address electrode, a dielectric layer covering the first and second display electrodes on the second substrate, an MgO protective layer covering the dielectric layer on the second substrate, discharge gases filled between the first and second substrates, a driver that drives the plasma display panel, and a controller that controls the driver so that a sustain pulse width of a sustain period may be 1 to 3.5 μs and wherein an atomic ratio of O to Mg in the MgO protective layer ranges from 1.0 to 0.98.

According to an aspect of the present invention, the sustain pulse width may be 1 to 3.5 μs. According to a non-limiting example, the sustain pulse width ranges from 1 to 3.0 μs.

According to an aspect of the present invention, the sustain period is 9 to 25 μs. According to a non-limiting example, the sustain period may be 10 to 25 μs.

According to an aspect of the present invention, the first sustain pulse width of the sustain period is 2 to 7.5 μs. According to a non-limiting example, the first sustain pulse width of the sustain period ranges from 2 to 7 μs.

According to an aspect of the present invention, the discharge gas comprises 5 to 30 parts by volume of Xe based on 100 part by volume of Ne. According to a non-limiting example, the discharge gas further includes more than 0 to 70 parts by volume of at least one gas selected from the group of He, Ar, Kr, O₂, N₂, and combinations thereof based on 100 parts by volume of Ne.

According to another embodiment of the present invention, there is provided a plasma display panel comprising at least one pair of first and second display electrodes disposed on a substrate; a dielectric layer covering the at least one pair of first and second display electrodes; and an MgO protective layer covering the dielectric layer, wherein an atomic ratio of O to Mg in the MgO protective layer ranges from 1.0 to 0.98

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial exploded perspective view showing a structure of a plasma display panel according to an embodiment of the present invention;

FIG. 2 is a schematic view showing a plasma display device including the plasma display panel of FIG. 1;

FIG. 3 is a driving waveform of the plasma display device of FIG. 2;

FIG. 4 is a schematic view showing an atomic structure of an MgO protective layer when more 0 atoms are included than Mg atoms;

FIG. 5 is a schematic view showing an atomic structure of an MgO protective layer when O atoms and Mg atoms are included stoichiometrically;

FIG. 6 is a graph showing a statistical delay time of the plasma display device according to Examples 2, 3, and 6, and Comparative Examples 1 to 4; and

FIG. 7 is a graph showing an occurrence of black noise in the gray scale depending on temperature.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to an embodiment of the present invention, a plasma display device is provided that includes a plasma display panel an address electrode disposed on a first substrate, a pair of first and second display electrodes disposed on the second substrate and crossing the address electrode, a dielectric layer covering the first and second display electrodes on the second substrate, an MgO protective layer covering the dielectric layer on the second substrate, discharge gases filled between the first and second substrates, a driver that drives the plasma display panel, and a controller that controls the driver so that a sustain pulse width of a sustain period may be 1 to 3.5 μs. An atomic ratio of O to Mg in the MgO protective layer ranges from 1.0 to 0.98.

Herein, in general, when it is mentioned that one layer or material is formed on or disposed on or covers a second layer or a second material, it is to be understood that the terms “formed on,” “disposed on” and “covering” are not limited to the one layer being formed directly on the second layer, but may include instances wherein there is an intervening layer or material between the one layer and the second layer.

The sustain pulse width is 1 to 3.5 μs. According to a non-limiting example, the sustain pulse width is 1 to 3.0 μs. When the sustain pulse width is 1 to 3.5 μs, the high-definition plasma display device has improved uniformity of images due to improved discharge stability.

The sustain period is 9 to 25 μs. According to a non-limiting example, the sustain period may be 10 to 25 μs. When the sustain period is 9 to 25 μs, the high-definition plasma display device has an improved uniformity of images due to an improved discharge stability.

The first sustain pulse width of the sustain period is 2 to 7.5 μs. According to a non-limiting example, the first sustain pulse width of the sustain period ranges from 2 to 7 μs. When the first sustain pulse width of the sustain period is 2 to 7.5 μs, the high-definition plasma display device has an improved uniformity of images due to an improved discharge stability.

The discharge gas includes 5 to 30 parts by volume of Xe based on 100 parts by volume of Ne. According to a non-limiting example, the discharge gas includes 7 to 25 parts by volume of Xe based on 100 parts by volume of Ne. When the discharge gas includes Xe and Ne within the above ratio, the discharge initiation voltage is decreased due to an increased ionization ratio of the discharge gas. When the discharge initiation voltage is decreased, the high-definition plasma display device has decreased power consumption and increased brightness.

According to a non-limiting example, the discharge gas may further include more than 0 to 70 parts by volume of at least one gas selected from the group consisting of He, Ar, Kr, O₂, N₂, and combinations thereof based on 100 parts by volume of Ne. According to a non-limiting example, the discharge gas includes 14 to 65 parts by volume of the gas selected from the group consisting of He, Ar, Kr, O₂, N₂, and combinations thereof based on 100 parts by volume of Ne. When the discharge gas includes at least one gas selected from the group consisting of He, Ar, Kr, O₂, N₂, and combinations thereof within the above ratio, the discharge initiation voltage is decreased due to an increased ionization ratio of the discharge gas. When the discharge initiation voltage is decreased, the high-definition plasma display device has decreased power consumption and increased brightness.

An embodiment of the present invention will hereinafter be described in detail with reference to the accompanying drawings. As those skilled in the art would realize, the described embodiments may be modified in various different ways, all without departing from the spirit or scope of the present invention.

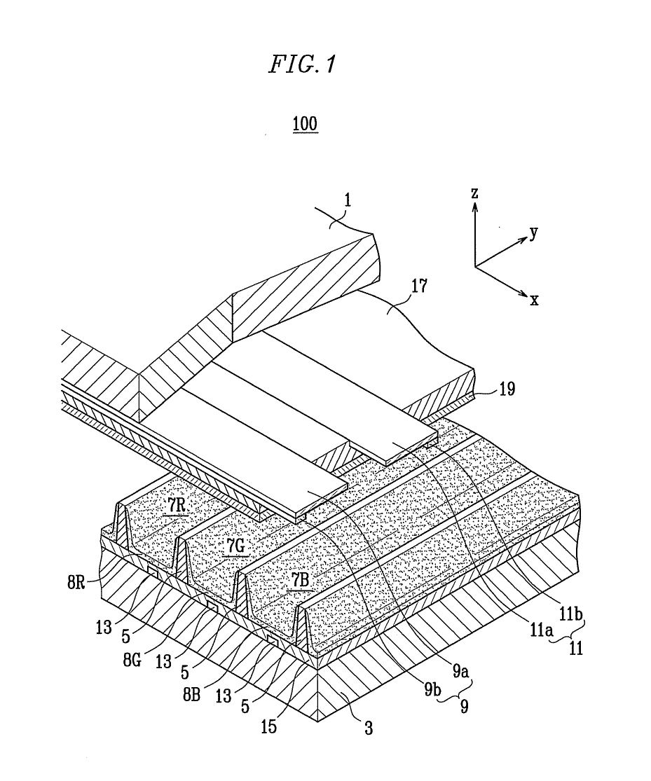

FIG. 1 is a partial exploded perspective view showing the structure of a plasma display panel according to one embodiment. Referring to the drawing, the PDP includes a first substrate 3, a plurality of address electrodes 13 disposed in one direction (a Y direction in the drawing) on the first substrate 3, and a first dielectric layer 15 disposed on the surface of the first substrate 3 covering the address electrodes 13. Barrier ribs 5 are formed on the first dielectric layer 15, and red (R), green (G), and blue (B) phosphor discharge cells 7R, 7G, and 7B are formed between the barrier ribs 5. Red (R), green (G), and blue (B) phosphor layers 8R, 8G, and 8B are disposed in the discharge cells 7R, 7G, and 7B.

The barrier ribs 5 may be formed in any shape as long as their shape can partition the discharge space, and the barrier ribs 5 may have diverse patterns. For example, the barrier ribs 5 may be formed as an open type, such as stripes, or as a closed type, such as a waffle, matrix, or delta shape. As further non-limiting examples, closed-type barrier ribs may be formed such that a horizontal cross-section of the discharge space is a polygon such as a quadrangle, triangle, or pentagon, or a circle or an oval.

Display electrodes 9 and 11, each including a pair of a transparent electrode 9a or 11a and a bus electrode 9b or 11b, are disposed in a direction crossing the address electrodes 13 (the X direction in the drawing) on one surface of a second substrate 1 facing the first substrate 3. Also, a second dielectric layer 17 and an MgO protective layer 19 are disposed on the surface of the second substrate 1 while covering the display electrodes.

The atomic ratio of O to Mg in the MgO protective layer ranges from 1.0 to 0.98. The MgO protective layer may further include an element selected from the group consisting of rare earth elements, and a combination thereof.

Discharge cells are formed at positions where the address electrodes 13 of the first substrate 3 are crossed by the display electrodes of the second substrate 1.

The discharge cells between the first substrate 3 and the second substrate 1 are filled with a discharge gas. As discussed above, the discharge gas includes 5 to 30 parts by volume of Xe based on 100 parts by volume of Ne. According to a non-limiting example, the discharge gas includes 7 to 25 parts by volume of Xe based on 100 parts by volume of Ne. The discharge gas may further include more than 0 to 70 parts by volume of at least one gas selected from the group consisting of He, Ar, Kr, O₂, N₂, and combinations thereof based on 100 parts by volume of Ne. According to a non-limiting example, the discharge gas includes 14 to 65 parts by volume of the gas selected from the group consisting of He, Ar, Kr, O₂, N₂, and combinations thereof based on 100 parts by volume of Ne.

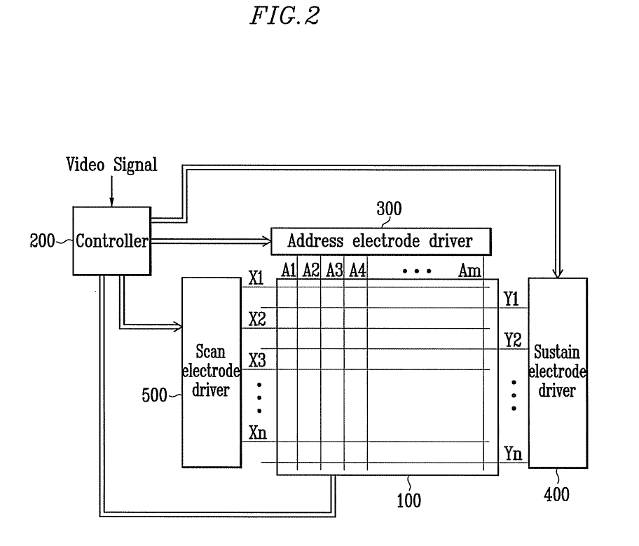

FIG. 2 is a schematic view showing a plasma display device according to an embodiment of the present invention. As shown in FIG. 2, the plasma display device according to one embodiment of the present invention includes a plasma display panel 100, a controller 200, an address electrode (A) driver 300, a sustain electrode (a second display electrode, X) driver 400, and a scan electrode (a first display electrode, Y) driver 500.

The plasma display panel 100 has the same structure as shown in FIG. 1.

The controller 200 receives video signals from the outside and outputs an address driving control signal, a sustain electrode (X) driving control signal, and a scan electrode (Y) driving control signal. The controller 200 divides one frame into a plurality of subfields, and each subfield is composed of a reset period, an address period, and a sustain period when the subfield is expressed based on temporal driving change.

The address driver 300 receives an address electrode (A) driving control signal from the controller 200, and applies a display data signal for selecting a discharge cell to be displayed to each address electrode.

The sustain electrode driver 400 receives a sustain electrode driving control signal from the controller 200, and applies a driving voltage to the sustain electrodes (X).

The scan electrode driver 500 receives a scan electrode driving control signal from the controller 200 and applies a driving voltage to the scan electrodes (Y).

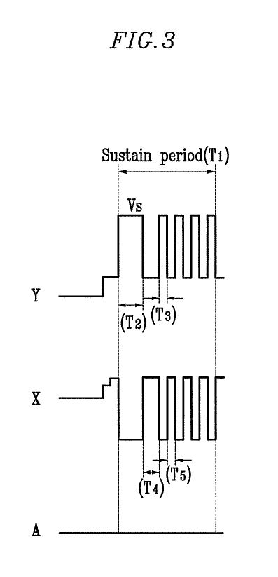

FIG. 3 shows a driving waveform of the plasma display panel illustrated in FIG. 2. As shown in FIG. 3, the first sustain discharge pulse of the Vs voltage at the sustain period (T₁) is applied to the scan electrode (Y) and the sustain electrode (X), alternately. If the wall voltage between the scan electrode (Y) and the sustain electrode (X) is generated, the scan electrode (Y) and the sustain electrode (X) are discharged by the wall voltage and the Vs voltage. Then, the process to apply the scan electrode (Y) with the sustain discharge pulse of the Vs voltage and the process to apply the sustain discharge pulse of the Vs voltage to the sustain electrode (X) are repeated a number of times corresponding to the weighted value indicated by the subfield.

Herein, the first sustain pulse width (T₂) of the scan electrode (Y) or the first sustain discharge pulse width (T₄) of the sustain electrode (X) is 2 to 7.5 μs. According to a non-limiting example, the first sustain pulse width (T₂) of the scan electrode (Y) or the first sustain discharge pulse width (T₄) of the sustain electrode (X) ranges from 2 to 7 μs. The sustain discharge pulse width (T₃) of the scan electrode (Y) or the sustain discharge pulse width (T₅) of the sustain electrode (X) is 1 to 3.5 μs. According to a non-limiting embodiment, the first sustain pulse width (T₂) of the scan electrode (Y) or the first sustain discharge pulse width (T₄) of the sustain electrode (X) ranges from 1 to 3.0 μs. The sustain period (T₁) is 9 to 25 μs. According to a non-limiting example, the sustain period (T₁) ranges from 10 to 25 μs.

According to one embodiment, the plasma display panel is driven by the driving waveform, and includes the discharge gas filled therein and the MgO protective layer prepared using an MgO sintered material doped with Ca. The plasma display panel has improved driving stability, discharge characteristics, and display quality.

The atomic ratio of O to Mg in the MgO protective layer ranges from 1.0 to 0.98.

When more O atoms are included in the MgO protective layer than a stoichiometric ratio to Mg, defects of the Mg atoms occur in the atomic structure of the MgO protective layer, and the defects are hydrated. Herein, when the atomic ratio of O to Mg is within the above range, the O atoms and the Mg atoms are included in the MgO protective layer in the stoichiometric ratio or with a slight excess of Mg atoms. Thus, discharge stability and response speed of the plasma display device are improved by preventing the defects of the MgO atom from occurring and being hydrated. Further, an occurrence of a low discharge in the specific gray scale is reduced.

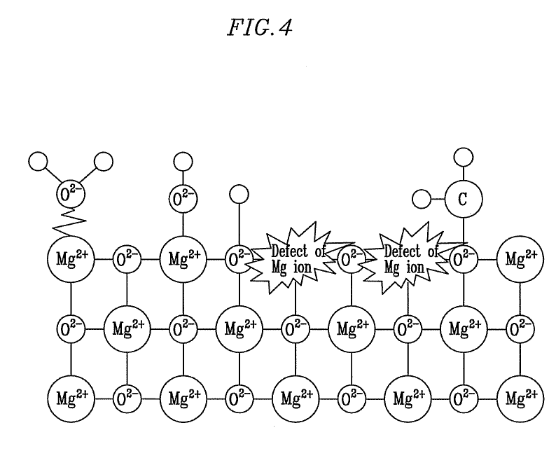

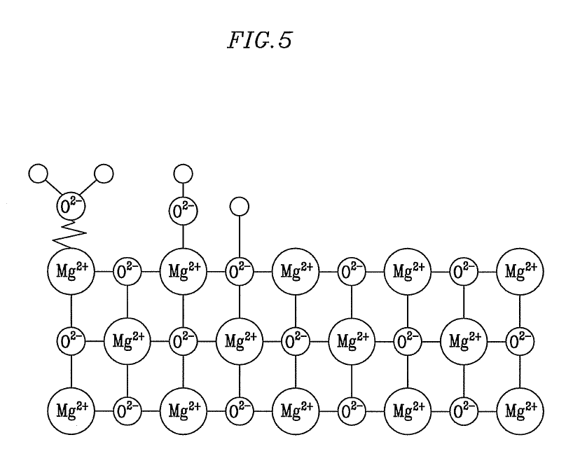

FIG. 4 is a schematic view showing an atomic structure of an MgO protective layer, when there are more O atoms than Mg atoms. FIG. 5 is a schematic view showing an atomic structure of a MgO protective layer, when O atoms and Mg atoms are included stoichiometrically.

As shown in FIG. 4, the Mg atoms and the O atoms bonding alternately to each other to form a cubic system. When more O atoms are included than Mg atoms, defects of the Mg atom are created in the atomic structure of the MgO protective layer, and the defects become hydrated.

As shown in FIG. 5, when O atoms and Mg atoms are included in the MgO protective layer in a stoichiometric ratio, defects of the Mg atom and hydration of such defects are prevented from occurring.

The method of fabricating the plasma display device is well known to persons skilled in this art, so a detailed description thereof will be omitted from this specification. However, the process for forming the MgO protective layer according to one embodiment of the present invention will be described.

The MgO protective layer covers the surface of the dielectric layer covering the display electrodes in the plasma display device to protect the dielectric layer from ionic impact of the discharge gas during the discharge.

The MgO protective layer is mainly composed of MgO having the atomic ratio of O to Mg ranging from 1.0 to 0.98.

The protective layer may be formed by a thick-film printing method utilizing a paste. However, a layer formed by the thick-film printing method has relative disadvantages in that the printed layer is weak against sputtering by ion bombardment and cannot reduce a discharge sustain voltage and a discharge firing voltage by secondary electron emission. Therefore, the protective layer is preferably formed by physical vapor deposition.

The method of forming the MgO protective layer by physical vapor deposition is preferably a plasma deposition method. Plasma deposition methods include methods using electron beams, deposition beams, ion plating, or magnetron sputtering.

The depositing material for the MgO protective layer is formed in a pellet shape and fired. Since the pellets decompose depending upon the size and shape thereof, it is desirable to optimize the size and shape of the pellets.

Further, since the MgO protective layer is contacted with the discharge gas, the components and the membrane characteristics thereof significantly affect the discharge characteristics. The MgO protective layer characteristics are significantly dependent upon the components and the coating conditions during deposition. The components should be chosen such that the MgO protective layer has the required membrane characteristics.

The following examples illustrate aspects of the present invention in more detail. However, it is understood that aspects of the present invention are not limited by these examples.

Manufacture of a Plasma Display Device

### EXAMPLE 1

Display electrodes having a stripe shape were formed on a soda lime glass substrate in accordance with a conventional process.

A glass paste was coated on the substrate formed with the display electrodes and fired to provide a second dielectric layer.

An MgO protective layer, in which the atomic ratio of O to Mg was 1, was formed on the second dielectric layer by ion plating. A plasma display device was manufactured using the fabricated second substrate. The sustain pulse width of a sustain period was 2.1 μs, the sustain period was 15 μs, and the first sustain pulse width of the sustain period was 2.1 μs. Also, the discharge gas included 11 parts by volume of Xe and 35 parts by volume of He based on 100 parts by volume of Ne.

### EXAMPLE 2

A plasma display device was manufactured according to the same method as in Example 1, excepting that the atomic ratio of O to Mg was 0.998.

### EXAMPLE 3

A plasma display device was manufactured according to the same method as in Example 1, excepting that the atomic ratio of O to Mg was 0.995.

### EXAMPLE 4

A plasma display device was manufactured according to the same method as in Example 1, excepting that the atomic ratio of O to Mg was 0.99.

### EXAMPLE 5

A plasma display device was manufactured according to the same method as in Example 1, excepting that the atomic ratio of O to Mg was 0.985.

### EXAMPLE 6

A plasma display device was manufactured according to the same method as in Example 1, excepting that the atomic ratio of O to Mg was 0.983.

### EXAMPLE 7

A plasma display device was manufactured according to the same method as in Example 1, excepting that the atomic ratio of O to Mg was 0.98.

### COMPARATIVE EXAMPLE 1

A plasma display device was manufactured according to the same method as in Example 1, excepting that the atomic ratio of O to Mg was 0.978.

### COMPARATIVE EXAMPLE 2

A plasma display device was manufactured according to the same method as in Example 1, excepting that the atomic ratio of O to Mg was 0.976.

### COMPARATIVE EXAMPLE 3

A plasma display device was manufactured according to the same method as in Example 1, excepting that the atomic ratio of O to Mg was 1.030.

### COMPARATIVE EXAMPLE 4

A plasma display device was manufactured according to the same method as in Example 1, excepting that the atomic ratio of O to Mg was 1.097.

Measurement of Discharge Delay Time of the Plasma Display Device

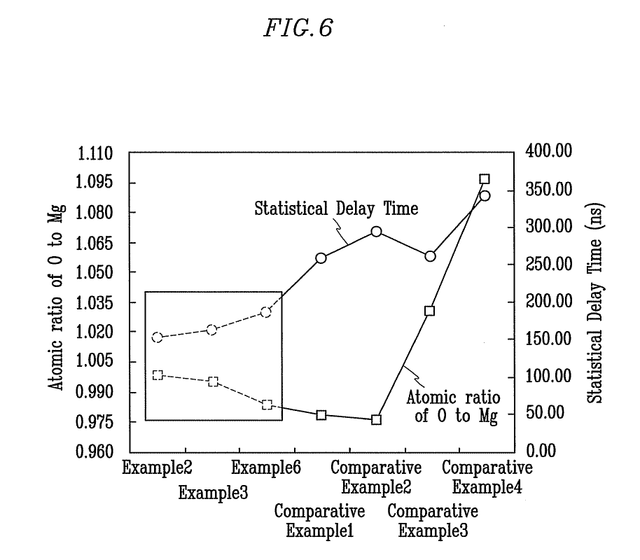

Statistical delay times of the plasma display devices according to Examples 1 to 7 and Comparative Examples 1 to 4 were measured. The measurement results of the plasma display devices of Examples 2, 3, and 6, and Comparative Examples 1 to 4, are shown in FIG. 6.

As shown in FIG. 6, the statistical delay times of the plasma display devices according to Examples 2, 3, and 6 are reduced in comparison to those of the plasma display device according to Comparative Examples 1 to 4.

The plasma display devices according to Examples 1, 4, 5, and 7 show similar statistical delay times to the plasma display devices according to Examples 2, 3, and 6.

Measurement of Occurrence of Black Noise in the Plasma Display Device

Plasma display devices according to Examples 1 to 7 and Comparative Examples 1 to 4 were driven at −5° C., 5° C., 15° C., 25° C., 40° C., 55° C., and 70° C. to observe the occurrence of black noise with the naked eye. Black noise is an address miss in which light is not emitted in the selected cell. The gray scale was divided into 255 levels.

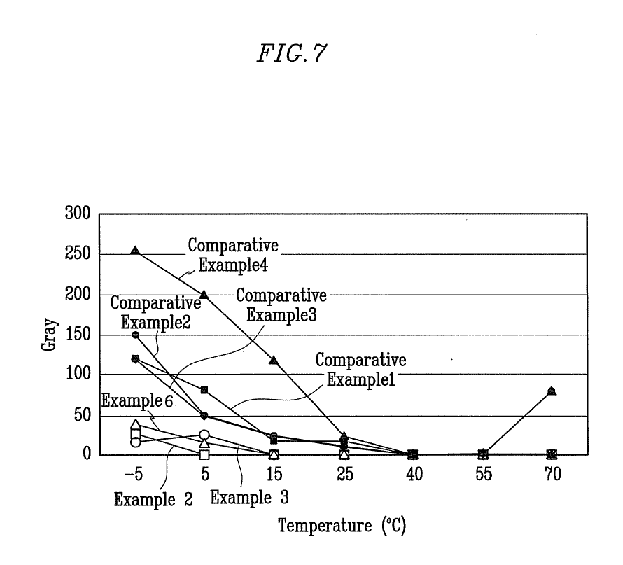

The measurement results for the plasma display devices according to Examples 2, 3, and 6, and Comparative Examples 1 to 4, are shown in FIG. 7. The plasma display devices according to Examples 1, 4, 5, and 7 show the similar statistical delay times as the plasma display devices according to Examples 2, 3, and 6.

As shown in FIG. 7, in the plasma display devices according to Examples 2, 3, and 6, black noise did not occur at the temperatures of 15° C., 25° C., 40° C., 55° C., and 70° C., and black noise occurred at a low temperature at a low gray scale. However, in the plasma display devices according to Comparative Examples 1 to 4, black noise occurred at the temperatures from −5° C. to 40° C., and the black noise occurred at a high gray scale. Further, in the plasma display device according to Comparative Example 4, black noise occurred at a high temperature of 70° C.

As described above, a plasma display device in which a sustain pulse width of a sustain period is 1 to 3.5 μs, a sustain period is 2 to 7.5 μs, and a discharge gas includes 5 to 30 parts by volume of Xe based on 100 parts by volume of Ne, has improved discharge stability and display quality when an MgO protective layer covering the dielectric layer covering the display electrodes is constructed to have an atomic ratio of O to Mg in the range of from 1.0 to 0.98.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel including
at least one pair of first and second display electrodes disposed on a substrate;
a dielectric layer covering the at least one pair of first and second display electrodes; and
an MgO protective layer covering the dielectric layer;
a driver that drives the plasma display panel; and
a controller that controls a sustain pulse width of a sustain period to be 1 to 3.5 μs,
wherein an atomic ratio of O to Mg in the MgO protective layer ranges from 1.0 to 0.98.

2. The plasma display device of claim 1, wherein the sustain pulse width is 1 to 3.0 μs.

3. The plasma display device of claim 1, wherein the sustain period is 9 to 25 μs.

4. The plasma display device of claim 3, wherein the sustain period ranges from 10 to 25 μs.

5. The plasma display device of claim 1, wherein the first sustain pulse width of the sustain period is 2 to 7.5 μs.

6. The plasma display device of claim 5, wherein the first sustain pulse width of the sustain period is 2 to 7 μs.

7. The plasma display device of claim 1, wherein the plasma display panel further comprises a discharge gas including 5 to 30 parts by volume of Xe based on 100 parts by volume of Ne.

8. The plasma display device of claim 7, wherein the discharge gas further comprises 0 to 70 parts by volume of at least one gas selected from the group consisting of He, Ar, Kr, O₂, N₂, and combinations thereof based on 100 parts by volume of Ne.
